(19) United States
(12) Patent Application Publication
(10) Pub. No.: US 2007/0103916 A1
(43) Pub. Date: May 10, 2007

(54) Lamp holder device with function element

(76) Inventor: Jeng-shyong Wu, Hsinchu (TW)

Correspondence Address: MCGLEW & TUTTLE, PC, P.O. BOX 9227, SCARBOROUGH STATION, SCARBOROUGH, NY, 10510-9227, US

(21) Appl. No.: 11/268,243

(22) Filed: Nov. 7, 2005

(51) Int. Cl. F21V 15/00

(52) U.S. Cl. 362/382; 362/362

(57) ABSTRACT

A lamp holder device having a function element comprises: a lamp base, a light emitting element, a set of conducting slices, a function element, a lamp holder, and a set of electrical wires, wherein a light emitting element is provided in the lamp base; extension arms are provided in the bottom of the lamp base for clipping the function element; said extension arms have side holes for the side of said function element held within can be outward protruded; the lamp holder to be installed with the lamp base is provided with electrical wires; the upper end of said electrical wires are provided with conducting slices having flanges. Accordingly, when the light emitting element, lamp base, lamp holder, and function element are assembled, an electric circuit is formed, while the light emitting element and function element can function as default. When the lamp base including the light emitting element is connected to the lamp holder and displaced or apart from each other, said function element is also displaced. Moreover, the conducting contact point of said function element and the conducting slices in the lamp holder are contacted in different places and different ways, so that said function element can function as default after its displacement.

### BACKGROUND OF THE INVENTION

1. Field of the Invention

The present invention relates to an improvement in the construction of a lamp holder, particular to an improved lamp holder, in which different lighting can be displayed no matter a lamp base is fastened or apart from the lamp holder by providing extension arms that can carry the function element with contact points in different heights in the bottom of said lamp base.

2. Description of the Prior Art

As generally known, series lamp strings are frequently used in festivities or decorations; particularly the Christmas lamps are widely used in Christmas seasons. However, light bulbs of conventional series lamp strings may come off due to shock or collision. In addition, the light bulbs will not work when the tungsten filaments of the bulbs are burned-out after a period of usage. It is troublesome to merely replace the bulb or lamp holder, while it costs much to replace the whole lamp string.

In order to overcome the above-mentioned shortcomings, U.S. Pat. No. 6,283,797 has proposed to provide a resistor in the lamp holder, in which when one bulb in series lamp strings are burned out, the resistor can act as a route so that other bulbs of series lamp strings can still work.

Accordingly, the present invention has been invented to solve the above-mentioned problems occurred in the prior art.

### SUMMARY OF THE INVENTION

An objective of the present invention is to provide a lamp holder device having a function element, in which a downward extending extension arm having the clip-on capability is provided in the bottom of said lamp base, and a function element having different function properties in accordance with displacement of the function element is provided in said extension arm, which enables different lighting display when the lamp base and lamp holder are fastened or apart from each other.

The lamp holder device having a function element in the present invention comprises: a lamp base, a light emitting element, a set of conducting slices, a function element, a lamp holder, and a set of electrical wire. Said light emitting element is provided in the lamp base, where extension arms in the bottom of said lamp base have side holes for the side of the function element held within can be outwardly protruded. When the entire components are assembled, an electric circuit is formed, while the light emitting element and function element can function as default. When said lamp base including light emitting element is connected to the lamp holder and displaced or apart from each other, said function element is also displaced. The conducting contact point of said function element and the conducting slices in the lamp holder are contacted in different places or different ways, which enables said function element to function as default after its displacement.

In the lamp holder device having a function element in the present invention, the function element being used may be single or multiple sets of resistors, PPTC (Polymeric Positive Temperature Coefficient Resistor), or fuses. The fuses being used may be resettable fuse, alarm fuse or temperature transmitting fuse.

In the lamp holder device having a function element in the present invention, at least a flange is provided on the conducting slices in the lamp holder, providing the function element with the conductivity. By allowing the side of said function element to have contact points in different heights, the light emitting element in the lamp base will not be turned off because the lamp base and lamp holder are loosen and apart from each other. On the contrary, said function element has different contact point with the conducting slices because the position of said lamp base relative to the lamp holder is changed, which changes the lighting display of said light emitting element, and serves as another purpose of the present invention.

In the lamp holder device having a function element according to the present invention, the function element can be contacted with the conducting slices in different places because said function element has several contact points in different heights, which allows the light emitting element to maintain bright state. When this is used in the series lamp string, the whole lamp string will not be off due to the loose of lamp base and being apart from the lamp string (this may impact the festivals or decoration atmosphere), which serves as another purpose of the present invention.

The detailed structure, application principle, purposes and functions of the present invention will be more apparent from the following detailed description taken in conjunction with the accompanying drawings.

### BRIEF DESCRIPTION OF THE DRAWINGS

FIG. 1 is a combination sectional view of the present invention;

FIG. 2 is a three-dimensional exploded view of the present invention;

FIG. 3a is a view showing the assembling of the lamp base and light emitting element according to the present invention;

FIG. 3b is an exploded sectional view of the lamp base and light emitting element according to the present invention;

FIG. 4 is a sectional view showing the disassembling of the lamp base and lamp holder according to the present invention;

FIG. 5 is a combination sectional view of the second embodiment according to the present invention;

FIG. 5a is an exploded sectional view of the lamp base and lamp holder according to the second embodiment of the present invention;

FIG. 5b is a sectional view showing the lamp holder being disassembled according to the second embodiment of the present invention;

FIG. 6a is a three-dimensional view of the function element according to the second embodiment of the present invention;

FIG. 6b is another three-dimensional view of the function element according to the second embodiment of the present invention;

FIG. 7 is a view showing the application of the present invention in the lamp strings;

FIG. 8 is a view showing the application of the present invention in the modeling lamp string;

FIG. 9 is a view showing the internal circuit of the function element according to the present invention.

### DETAILED DESCRIPTION OF THE PREFERRED EMBODIMENTS

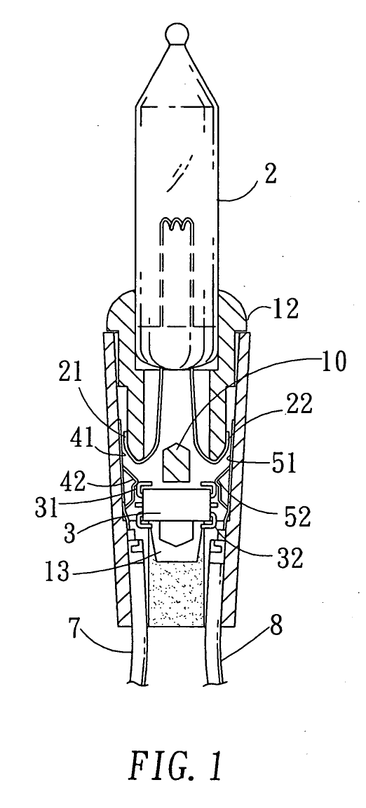

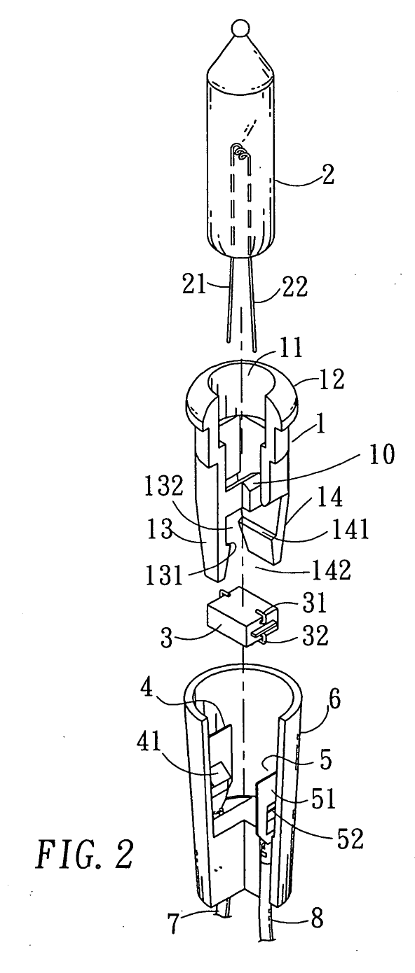

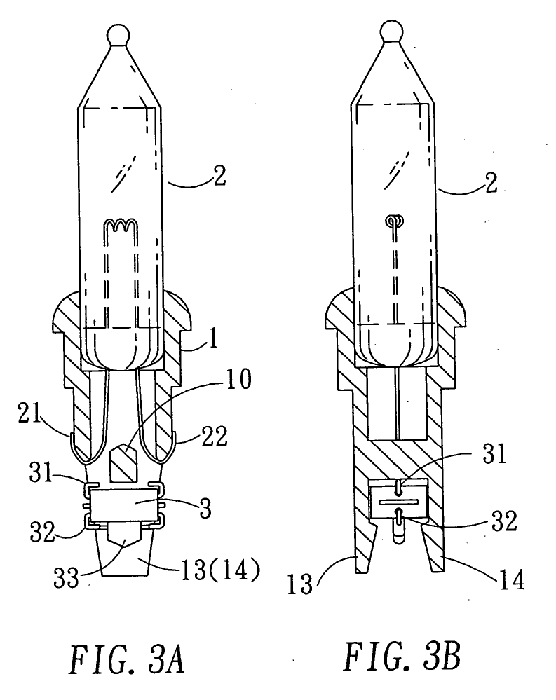

The lamp holder device having a function element in the present invention, as shown in FIGS. 1 and 2, comprises: a lamp base 1, a light emitting element 2, a function element 3, a set of conducting slices 4 and 5, a lamp holder 6, and a set of electrical wires 7 and 8. Referring to FIGS. 3A and 3b, said lamp base 1 has an accommodation space 11 that allows the light emitting element 2 to be inserted, in which a crotched part 10 formed with said lamp base 1 is provided. The upper end of said crotched part is diamond shaped, while the upper end of lamp base 11 is provided with an outward protruding neck flange

A neck flange 12, which allows to properly cover the fringe of lamp holder 6 when it is assembled with the lamp holder 6; two downward extending extension arms 13 and 14 are provided in the bottom of said lamp base 1, and an accommodation space is provided properly between the two extension arms 13 and 14, in which the interior wall is provided with inward protruding flat-top 131 and 141. The two sides of said extension arms 13 and 14 are not completely contacted with each other, and thus a proper interval is formed having a rectangular hole or a downward penetrating channel 132 and 142. The present embodiment uses the downward penetrating channel as an example.

Said light emitting element 2 may be a LED lamp or a tungsten lamp. The present embodiment uses a lamp bulb as an example. The center of light emitting element 2 is provided with downward extending filaments 21 and 22. When light emitting element 2 is inserted into the lamp base 1, said filaments 21 and 22 are diverged outward due to the contact with the crotched part 10 in the lamp base, and passed out of the channels 132 and 142 between two extension arms 13 and 14. When the lamp base 1 is being inserted into the lamp holder 6, the filaments 21 and 22 are formed and extended downward to flip to outside the lamp base. Then, the filaments are contacted and conducted with conducting slices 4 and 5 in the lamp holder 6.

Said function element 3, provided between two extension arms 13 and 14 in the bottom of the lamp base, can be clipped and held stably on the flat-top 131 and 141 of said extension arms 13 and 14. A plurality of electrical devices with control functions in the interior of said function element 3 provide conductivity by using the outward extending contact points on its side in the same height. In the present embodiment, the sides of said function element 3 have two sets of first contact point 31 and second contact point 32 in different heights. The preset function of first contact point 31 and second contact point 32 may be different or the same. When said function element 3 is provided between the extension arms 13 and 14 in the bottom of the lamp base, the first contact point 31 and second contact point 32 on the two sides are located on the channel 131 and 141 of extension arms 13 and 14, so that the contact points can be contacted externally. Moreover, a protruding insert pointer 33 is provided in one direction of said function element 3, by which the function element can be inserted correctly, and thus the damage of lamp strings caused by improper installation can be avoided.

Said conducting slices 4 and 5 provided in the lamp holder 6 mainly provide with contact and conductivity for the light emitting element 2 and function element 3. The upper parts 41 and 51 of said conducting slices 4 and 5 are formed as slice-shaped and attached to the interior wall of said lamp holder 6. Two inward protruding flanges 42 and 52 are formed on the surface of said lamp holder 6. The electrical wires 7 and 8 are connected to the lower ends of said lamp holder 6, and said electrical wires 7 and 8 are connected to power or lamp holder of other series lamp strings.

Said function element 3 may be single or multiple sets of resistance, or single or multiple sets of PPTC (Polymeric Positive Temperature Coefficient Resistor). Said function element 3 may be signal or multiple sets of fuses. The fuses may be resettable fuse, alarm fuse or temperature transmitting fuse.

When the whole components have been assembled, as shown in the figure, besides filaments 21 and 22 of said light emitting element 2 and slice-shaped upper part 41 and 51 of conducting slices 4 and 5 are contacted and conducted, the first contact point 31 and second contact point 32 of said function element 3, which is clipped and held by the extension arms 13 and 14 of said lamp base 1, are contacted with the flanges 42 and 52 of conducting slices 4 and 5 respectively. As such, through the preset function of said function element 3, the light emitting element 2 generates lighting changes before the lamp base 1 is not apart from the lamp holder 6.

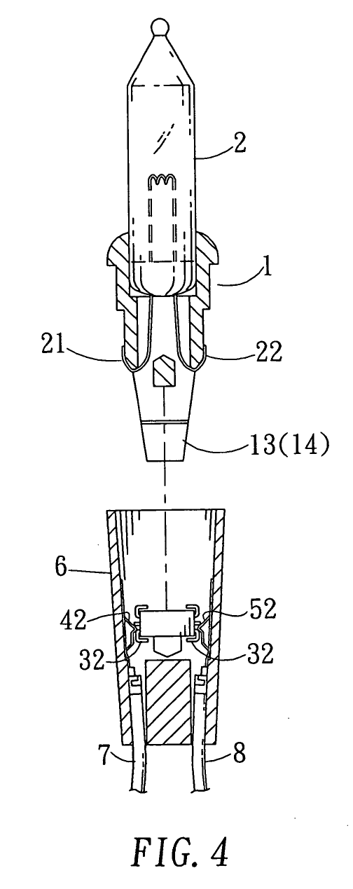

When the lamp base 1 is apart from lamp holder 6 due to external force (i.e. man-made or natural factor, such as wind power), as shown in FIG. 4, the function-element 3 that have originally been held by the extension arms 13 and 14 move upward due to the upward movement of said extension arms 13 and 14. Accordingly, the second contact point 32 in the lower position contacts with the flanges 42 and 52 of conducting slices 4 and 5. Therefore, if lamp base 1 only moves upward in a few distance, filament 21 and 22 of light emitting element and slice-shaped upper parts 41 and 51 of conducting slices 4 and 5 are still contacted, light emitting element 2 still can present lighting changes in accordance with the preset function by second contact point 32 of said function element 3. Or, if lamp base 1 is completely apart from said lamp holder 6, that is, the filaments 21 and 22 of light emitting element 2 and the slice-shaped upper parts 41 and 51 of conducting slices 4 and 5 are apart from each other without contact, the interior of said lamp holder still maintains the conducting state due to the contact between the second contact point 32 of said function element 3 and the flanges 42 and 52 of conducting slices 4 and 5, so that the power of lamp string connected in series may not cut off.

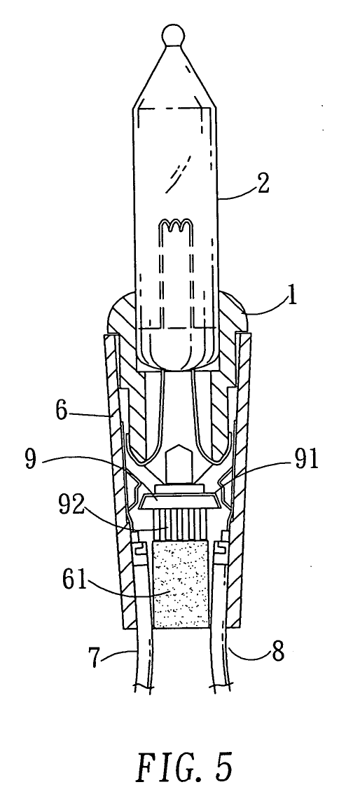

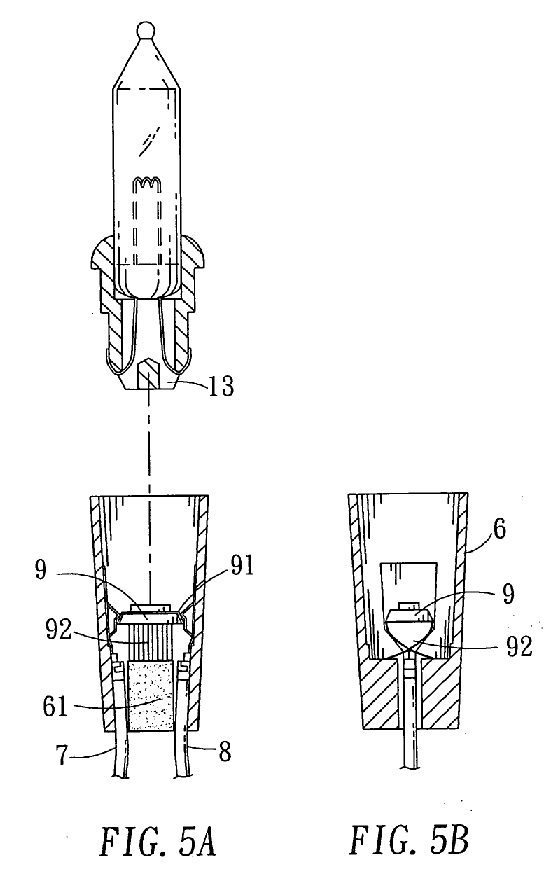

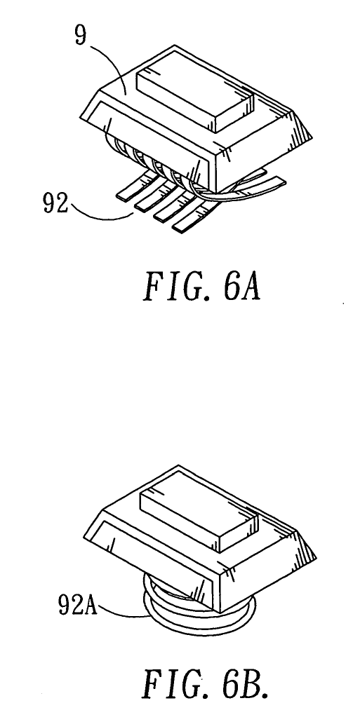

FIGS. 5, 5A, and 5B represent another embodiment of the lamp holder device having a function element in the present invention. A function element 9 with the contact point is set outside is provided; the upper end of said function element 9 is cap shaped; its upper surface is provided with the conducting materials 91 that can be applied to said conducting circuit. Said conducting materials may be metal materials or conducting plastics with the conducting capability; the larger upper surface can be provided in the bottom of extension arms 13 and 14 of said lamp base, and is suppressed by the extension arms 13 and 14 of said lamp base. The lower surface of said function element 9 is composed of insulating materials to connect the elasticity element 92 provided in its bottom. Said elasticity element 92 may be crotched elastic slice or spiral spring 92A (as shown in FIGS. 6A and 6B). Also, a chunk 61 is provided in the bottom of said lamp holder 6, so that the function element 9 can be provided on the chunk 61 by means of said elasticity element 92, and be suppressed by the extension arms 13 and 14 of said lamp base.

Accordingly, during implementation, besides the filaments 21 and 22 of light emitting element 2 have been contacted and conducted with the slice-shaped upper part 41 and 51 of said conducting slices 4 and 5, said function element 9 being suppressed by the extension arms 13 and 14 of said lamp base 1 are not contacted with the flanges 42 and 52 of said conducting slices 4 and 5.

When lamp base 1 is apart from the lamp holder 6 due to external force (i.e. man-made or natural factor, such as wind power), the function element 9 that has originally suppressed by the extension arms 13 and 14, due to lose of suppressing force, restores the elasticity by means of the elasticity element 92, and moves said function element 9 upward, so that the conducting materials 91 provided in the exterior of said function element 9 contact with the flanges 42 and 52 of conducting slices 4 and 5 due to the upward movement. Accordingly, the interior of said lamp holder remains as the route, so that the power of series lamp strings will not be cut off.

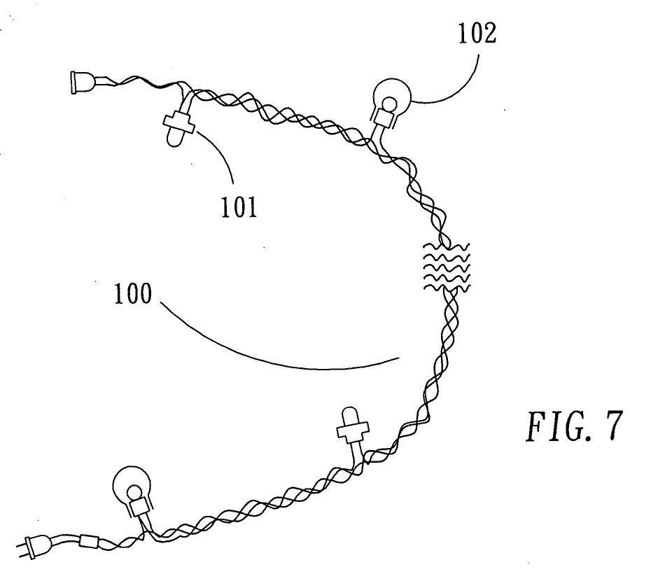

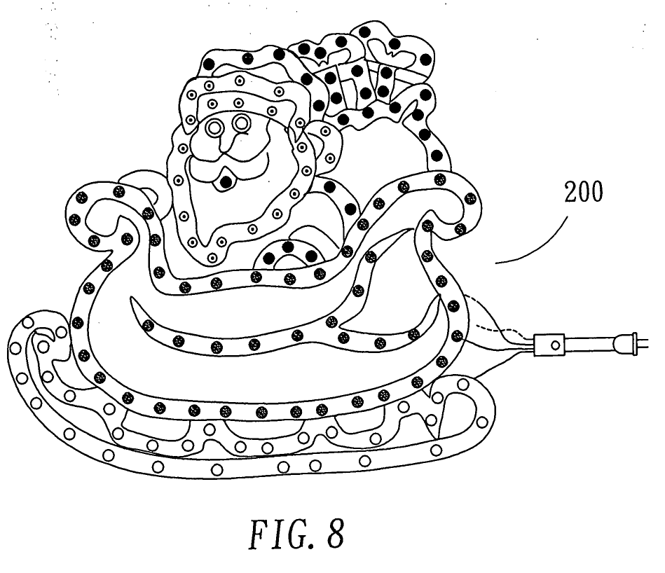

Referring to FIG. 7, when the lamp holder device having a function element in the present invention is used in the lamp string 100, several light emitting elements 101 and 102 that may be bulbs or LED are provided, and another end of electrical wires of each light emitting element 101 and 102 is connected in series, parallel, or in both series and parallel as lamp strings. Said light emitting elements 101 and 102 are connected in series, due to the installation of said function element in the lamp holder, the power of the whole lamp string 100 will not be cut off because the lamp base is apart and comes off. Particularly, when the present is applied to a specific modeling lamp string 200 (as shown in FIG. 8), the predicament in which the power of lamp strings that are frequently used in special festivals or occasions are cut off because a bulb comes off and thus loses the lighting effects can be avoided.

The light emitting element used in the present invention may be a light emitting element made of a plurality of parallel tungsten bulbs or LED bulbs packed as a unity with multiple colors LED cells (i.e. red LED, green LED, blue LED).

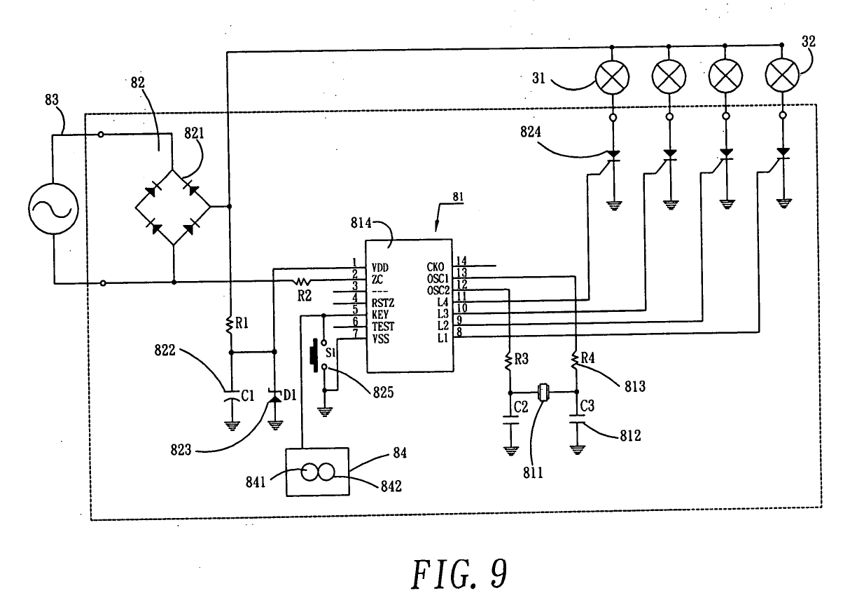

The function elements 3 and 9 used in the present invention (its interior can be shown as FIG. 9) comprise:

An IC chip 81, in which the oscillation circuit is composed of the oscillator 811, capacitance 812, resistance 813 and IC 814, generates fundamental reference frequency needed for the internal operation of IC 814. Each action in said IC 814 can use such frequency as a standard to achieve the synchronization function, and has the capability of receiving power source or signals, operating default functions, and sending control signals.

An IC chip assisted parts assembly 82, includes a rectifier 821, capacitance 822, constant voltage diode 823, SCR 824, and a switch 825 to have the function of regulating, varying, and controlling the intensity and quality of the capability to vary, regulate, stabilize, drive, and activate said string lamp set;

A power connector 83, which is connected to multiple sets of IC chips 81 and assisted parts assembly 82; and

A signal receiving and delivering mechanism 84, which is used for connecting power and the IC chip 81 and its assisted parts assembly 82 and uses the wireless signal of infrared rays (IR) or microwave radio frequencies (RF); the signal receiver mechanism 841 and receiver 72 are integrated as a unity. In consideration of practical utility, the IC chip 81 is provided with the preset On/Of or reset function to switch to On/Off automatically or reset. The entire components are then connected with electrical wires 85 to form an integral whole.

Multiple sets of lamps can be connected in series during usage by using the power connector to connect to power. IC chip and its assisted parts assembly can be used to drive multiple sets of lamps, so that the light emitting device can generate light or shade. Then, any of the IC chips can be used to generate signals that are transmitted to each set of IC chip, while activating (START) or resetting (RESET) each string of lamp sets, controlling to have the same preset electrical functions, and generating the effect of synchronously operating multiple strings of lamp sets.

As understood from the above descriptions, the lamp holder device having a function element according to the present invention allows bulbs in the series lamp string to be bright even when one or more bulbs or lamp holder are apart, which overcomes the shortcoming occurred in the conventional series lamp string that the whole lamp string may be off when a bulb is burned out or a lamp holder is apart. Also, the present invention has not yet been made public, which is consistent with relevant Patent Law.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A lamp holder device having a function element, comprises:
a light emitting element;
a lamp base for accommodating said light emitting element, in which a space is provided for accommodating said light emitting element; one end of said lamp base is provided with extension arms;
a lamp holder, which allows said lamp base to be inserted; its interior is provided with conducting slices having flanges; the lower end of said lamp holder is connected with electrical wires; and
a function element, which is provided in the extension arms of said lamp base; the outer surface of said function element is provided with conducting contact points that can be contacted and conducted with the exterior conducting slices.

2. The lamp holder device having a function element as claimed in claim 1, wherein the conducting contact point provided in the exterior part of said function element may be one or more; each conducting contact point can be located in different heights, which allows different contact points to be contacted and conducted with conducting slices when the function element is displaced.

3. The lamp holder device having a function element as claimed in claim 1, wherein one end of said function element has an insert index.

4. The lamp holder device having a function element as claimed in claim 1, wherein said function element is clipped and held by the flat-top formed on the extension arm of the lamp base.

5. The lamp holder device having a function element as claimed in claim 1, wherein the accommodation space in said lamp base is provided with a crotched part.

6. The lamp holder device having a function element as claimed in claim 1, wherein the extension arms provided in said lamp base may be one or more; each extension arm may be completely or incompletely contacted.

7. The lamp holder device having a function element as claimed in claim 6, wherein each of said extension arms has a channel for the function element being held within to be contacted externally.

8. The lamp holder device having a function element as claimed in claim 6, wherein said extension arms have a flat-top for holding and fastening said function element; a longitudinal feed through is provided so that said function element being held within the extension arms can be contacted externally.

9. The lamp holder device having a function element as claimed in claim 1, wherein said light emitting element may be tungsten bulbs or LED.

10. The lamp holder device having a function element as claimed in claim 1, wherein said light emitting element may be tungsten bulbs or LED with different or same color.

11. The lamp holder device having a function element as claimed in claim 1, wherein said function element may be single or multiple sets of resistance.

12. The lamp holder device having a function element as claimed in claim 1, wherein said function element may be single or multiple sets of PPTC (Polymeric Positive Temperature Coefficient Resistor).

13. The lamp holder device having a function element as claimed in claim 1, wherein said function element may be single or multiple sets of fuses.

14. The lamp holder device having a function element as claimed in claim 13, wherein said fuse may be a resettable fuse.

15. The lamp holder device having a function element as claimed in claim 13, wherein said fuse may be an alarm fuse.

16. The lamp holder device having a function element as claimed in claim 13, wherein said fuse may be a temperature transmitting fuse.

17. The lamp holder device having a function element as claimed in claim 1, wherein said function element can be the combination of the rectification controller and function controller.

18. The string lamps device as claimed in claim 17, wherein said rectification controller is referred to as one that is composed of electrical devices such as resistance, capacitance, bridge rectifier, and zener diode, and has the function of regulator, rectification, and transformation.

19. The string lamps device as claimed in claim 17, wherein said function controller is referred to as one that is composed of IC and electrical devices, and has the function of turning on/off, counter, crescendo, diminuendo, in order, or out of order function.

20. The string lamps device as claimed in claim 17, wherein said function controller is referred to as one that includes synchronous control electrical devices and generates predetermined frequency to achieve synchronous operation.

21. The string lamps device as claimed in claim 17, wherein said function controller is referred to as one that has preset IR or RF signal receiving devices and receives preset signals to achieve remote control.

22. A lamp holder device having a function element, comprises:
a light emitting element;
a lamp base having a space for accommodating said light emitting element; one end of said lamp base has extension arms;
a lamp holder, which allows said lamp base to be inserted and has conducting slices that are provided with flanges; its lower end is connected with electrical wires; and
a function element, which is provided in the bottom of extension arm of said lamp base; its electrical materials are provided outside, while one end is provided with elasticity element.

23. The lamp holder device having a function element as claimed in 22, wherein said function element is formed with the elasticity element provided in the bottom as a unity.

24. The lamp holder device having a function element as claimed in 22, wherein the elasticity element in the bottom of said function element may be elastic slice or spring.

25. The lamp holder device having a function element as claimed in 22, wherein the conducting material of said function element is applied to the exterior surface of said function element.

26. The lamp holder device having a function element as claimed in 22, wherein a flat-top is provided in said lamp holder for accommodating the elasticity element of said function element.

27. The lamp holder device having a function element as claimed in 22, wherein said function element may be the combination of a rectification controller and a function controller.

28. The string lamps device as claimed in claim 27, wherein said rectification controller refers to one that is composed of electrical devices such as resistance, capacitance, bridge rectifier, and zener diode, and has the function of regulating, transforming voltage, and rectifying.

29. The string lamps device as claimed in claim 27, wherein said function controller is referred to as one that is composed of IC and electrical devices, and has the function of turning on/off, counter, crescendo, diminuendo, in order, or out of order function.

30. The string lamps device as claimed in claim 27, wherein said function controller is referred to as one that includes synchronous control electrical devices and generates predetermined frequency to achieve synchronous operation.

31. The string lamps device as claimed in claim 27, wherein said function controller is referred to as one that has preset IR or RF signal receiving devices and receives preset signals to achieve remote control.

32. The lamp holder device having a function element as claimed in 22, wherein said function element may be single or multiple sets of resistance.

33. The lamp holder device having a function element as claimed in 22, wherein said function element may be single or multiple sets of PPTC (Polymeric Positive Temperature Coefficient Resistor).

34. The lamp holder device having a function element as claimed in 22, wherein said function element may be single or multiple sets of fuses.

35. The lamp holder device having a function element as claimed in 34, wherein said fuse may be the resettable fuse.

36. The lamp holder device having a function element as claimed in 34, wherein said fuse may be the alarm fuse.

37. The lamp holder device having a function element as claimed in 34, wherein said fuse may be the temperature transmitting fuse.

38. A lamp holder device having a function element, comprises:
a light emitting element with its surface provided a plurality of conducting wires in connection to the circuit;
a lamp base having internal and external end, where a plurality of holes are provided to pass through; the exterior of said lamp base is provided with a space for accommodating said light emitting element; the conducting wires of said light emitting element are passed through said holes and extended to the interior of said lamp base;
a lamp holder having upper and lower end, where holes are provided to pass through; the upper end of said lamp holder is provided for said lamp base to be inserted; conducting slices are provided in the middle of said holes, so that the conducting slices can be connected to the conducting wires of said light emitting element; the bottom of said conducting slices is connected to said electrical wires, which are passed through the lower hole of said lamp holder and extended outward, so that it is connected to the power; and
a function element with its surface is provided with a plurality of conducting contact points; said function element is provided between the conducting slices of said lamp holder, and is connected to the interior of said lamp base;
When the above-mentioned components have been assembled, an electric circuit is formed; said light emitting element and function element function as default respectively; When said lamp base including the light emitting element is connected to said lamp holder, and displaced and apart from each other, said function element is displaced; the conducting contact point of said function element and conducting slices of said lamp holder are contacted in different places or in different ways, which enables said function element to function as default after its displacement.

39. The lamp holder device having a function element as claimed in 38, wherein said conducting slices in the lamp holder have flanges.

40. The lamp holder device having a function element as claimed in 38, wherein said conducting slices in the lamp holder have a crotched elastic slice.

41. A lamp holder device having a function element, comprises:
a light emitting element with its surface provided a plurality of conducting wires in connection to the circuit;
a lamp base having internal and external end, where a plurality of holes are provided to pass through; the exterior of said lamp base is provided with a space for accommodating said light emitting element; the conducting wires of said light emitting element are passed through said holes and extended to the interior of said lamp base; the interior is provided with extension arms;
a lamp holder having upper and lower end, where holes are provided to pass through; the upper end of said lamp holder is provided for said lamp base to be inserted; conducting slices are provided in the middle of said holes, so that the conducting slices can be connected to the conducting wires of said light emitting element; the bottom of said conducting slices is connected to said electrical wires, which are passed through the lower hole of said lamp holder and extended outward, so that it is connected to the power; and
a function element with its surface is provided with a plurality of conducting contact points; said function element is provided in the extension arms of said lamp holder;
When the above-mentioned components have been assembled, an electric circuit is formed; said light emitting element and function element function as default respectively; When said lamp base including the light emitting element is connected to said lamp holder, and displaced and apart from each other, said function element is displaced, but remains between the conducting slices in said lamp holder; the conducting contact point of said function element and conducting slices of said lamp holder are contacted in different places or in different ways, which enables said function element to function as default after its displacement.

42. The lamp holder device having a function element as claimed in claim 41, wherein said function element is clipped and held by the flat-top formed on the extension arms of said lamp base.

43. The lamp holder device having a function element as claimed in claim 41, wherein the accommodation space of said lamp base is provided with a crotched part.

44. A lamp holder device having a function element, comprises:
a light emitting element with its surface provided a plurality of conducting wires in connection to the circuit;
a lamp base having internal and external end, where a plurality of holes are provided to pass through; the exterior of said lamp base is provided with a space for accommodating said light emitting element; the conducting wires of said light emitting element are passed through said holes and extended to the interior of said lamp base; the interior is provided with extension arms;
a lamp holder having upper and lower end, where holes are provided to pass through; the upper end of said lamp holder is provided for said lamp base to be inserted; conducting slices are provided in the middle of said holes, so that the conducting slices can be connected to the conducting wires of said light emitting element; the bottom of said conducting slices is connected to said electrical wires, which are passed through the lower hole of said lamp holder and extended outward, so that it is connected to the power; and
a function element with its surface is provided with a plurality of conducting contact points; one end of said function element is provided with elasticity element that is provided between the conducting slices of said lamp holder and connected to the extension arms in said lamp base;
When the above-mentioned components have been assembled, an electric circuit is formed; said light emitting element and function element function as default respectively; When said lamp base including the light emitting element is connected to said lamp holder, and displaced and apart from each other, said function element is displaced, but remains between the conducting slices in said lamp holder; the conducting contact point of said function element and conducting slices of said lamp holder are contacted in different places or in different ways, which enables said function element to function as default after its displacement.

45. The lamp holder device having a function element as claimed in claim 44, wherein said conducting slices in the lamp holder have flange.

46. The lamp holder device having a function element as claimed in claim 44, wherein said conducting slices in the lamp holder have a crotched elastic slice.
